(19) United States
(12) Patent Application Publication
(10) Pub. No.: US 2021/0143450 A1
(43) Pub. Date: May 13, 2021

(54) FLOATING FRAME PLATE ASSEMBLY

(71) Applicant: ITN Energy Systems, Inc., Littleton, CO (US)

(72) Inventor: Garrett Scott KATO, Arvada, CO (US)

(21) Appl. No.: 16/622,718

(22) PCT Filed: Jun. 13, 2018
(86) PCT No.: PCT/US2018/037309

§ 371 Date: Dec. 13, 2019

Related U.S. Application Data
(60) Provisional application No. 62/518,953, filed on Jun. 13, 2017.

(51) Int. Cl. H01M 8/0258; H01M 8/0273; H01M 8/0267; H01M 8/18

(52) U.S. Cl. CPC H01M 8/0258; H01M 8/188; H01M 8/0267; H01M 8/0273

(57) ABSTRACT

A cell plate assembly has a frame body and a cell plate in fluidic communication. The cell plate is coupled to the frame body using a flexible member, which allows for some independent movement of the cell plate vis-à-vis the frame body. A plurality of cell plate assemblies may be coupled together to form a cell stack. The cell stack may be put to use in a redox flow battery.

The rechargeable flow battery (e.g., a redox flow battery) stores chemical energy in electrolyte solutions that contain electro-active elements. Conversion of this chemical energy to electrical energy may be captured and used to power a variety of devices and/or delivered to a power grid.

A typical rechargeable flow battery will have one or more cells. The cell will have an anolyte solution portion and a catholyte solution portion. These portions are separated by a membrane. Reservoirs containing additional anolyte and catholyte solutions are fluidically coupled to the anolyte portion and catholyte portion of the cell, respectively. As each electrolyte solution is circulated through its respective portion of the cell, the membrane allows for proton exchange between the anolyte solution and the catholyte solution. A current collector (e.g., an electrode) transfers the energy associated with the electron exchange between the anolyte and the catholyte to or from a power source depending on whether the redox-flow battery is being charged or discharged.

Current redox flow technology is limited by several issues. Examples of these issues include membrane fouling, cross contamination of electrolyte solutions, electrical shunt paths, and increased fluid resistance. Additionally, preventing cross contamination of electrolyte solutions between cells and between the portions of a cell while reducing manufacturing costs continues to be challenging with current redox flow technology.

It is with respect to these and other considerations that aspects of the technology have been disclosed. Also, although relatively specific problems have been discussed, it should be understood that the technology disclosed herein should not be limited to solving the specific problems identified in the background or the disclosure.

Redox Flow Battery

Aspects of the technology relate to a redox flow battery with a cell plate and a frame, together which form a frame plate assembly. In embodiments, multiple frame plate assemblies are stacked together to form a cell stack. The cell plates are fluidically coupled to the frame of the frame plate assembly. In aspects of the technology, a flexible member is used to couple a fluid channel of the frame to the cell plate. The flexible member may allow some movement between the frame and the cell plate assembly such that the cell plate may move independently from the frame. In this way, the cell may be said to be “floating” from the frame. In aspects of the technology, such independent movement may allow the frame of the frame plate assembly to have a different flatness than the flatness of the cell plate. This may allow, for some applications, a decreased manufacturing tolerance for the frame of the frame plate assembly while still maintaining an appropriately high manufacturing tolerance for the frame plate to enable proper sealing between frame plates of a cell stack assembly.

The cell stack is fluidically coupled to a reservoir, in aspects, using manifold inserts (e.g., piping) to provide electrolyte solutions from a cell reservoir to the cell stack. In aspects of the technology, the frame may house an electrolyte pathway which feeds and/or returns electrolytes from a frame channel to a cell plate. Frame channels across frame plates in a cell stack may align to form a combined channel, which channel may feed multiple cell plates of the cell stack.

In aspects of the technology, a redox cell stack includes a frame. The frame includes a plurality of electrolyte frame channels in fluidic communication with a plurality of electrolyte pathways, each electrolyte pathway coupled to a flexible member. The redox cell stack may include a cell plate coupled to each flexible member such that the frame and cell plate float relative to each other in a cell stack of a redox flow battery. In aspects, the frame, the plurality of electrolyte pathways, and the cell form a first frame plate assembly.

Additionally, a redox cell stack may include a frame having a rectangular prism body with a front face, a back face, and four side faces. The frame may have a first catholyte supply frame channel disposed on the rectangular prism body, a first catholyte return frame channel disposed on the rectangular prism body, a first anolyte supply frame channel disposed on the rectangular prism body, and a first anolyte supply frame channel disposed on the rectangular prism body. In addition, a first catholyte supply pathway may be disposed within the rectangular prism body. In aspects, the first catholyte supply pathway is in fluidic communication with the first catholyte supply frame channel. Additionally, the first catholyte supply pathway may have a frame channel end and a cell end, the cell end being coupled to a first flexible member.

Additionally, a first catholyte return pathway may be disposed within the rectangular prism body. In aspects, the first catholyte return pathway is in fluidic communication with the first catholyte return frame channel. Additionally, the first catholyte return pathway may have a frame channel end and a cell end, with the cell end being coupled to a second flexible member.

In aspects, a first anolyte supply pathway is disposed within the rectangular prism body. The first anolyte supply pathway may be in fluidic communication with the first anolyte supply frame channel, with the first anolyte supply pathway having a frame channel end and a cell end, and the cell end being coupled to a third flexible member.

In addition, a first anolyte return pathway may be disposed within the rectangular prism body, wherein the first anolyte return pathway is in fluidic communication with the first anolyte return frame channel, the first anolyte return pathway having a frame channel end and a cell end, the cell end being coupled to a fourth flexible member.

Further, a first cell plate may have a first orifice coupled to the first flexible member, a second orifice coupled to the second flexible member, the third orifice coupled to the third flexible member, and the fourth orifice coupled to the fourth flexible member.

In aspects, the frame, the first catholyte supply pathway, the first catholyte return pathway, the first anolyte supply pathway, the first cell plate, and the cell form a first frame plate assembly.

In aspects, a redox cell stack of includes a cell plate that has a flatness of at least 0.0005″ per linear 1″ while the frame body has a flatness of greater than 0.005″ per linear 1″.

In additional aspects, a redox stack is one with a cell plate that rotates about a pitch axis up to 3° degrees while the frame remains stationary relative to the cell plate.

In additional aspects, the redox cell stack includes at least one framing member extending through the frame body substantially orthogonal to a front face and back face. The redox cell stack may further include a second frame plate assembly disposed proximate to the front face of the first frame plate assembly. The framing members may extend through a second frame body of a second front face and a second back face of the second frame plate assembly.

The second frame plate assembly may have a second catholyte supply frame channel in fluidic communication with the first catholyte supply frame channel, a second catholyte return frame channel in fluidic communication with the first catholyte return channel, a second anolyte supply frame channel in fluidic communication with the first anolyte supply frame channel, and a second anolyte return frame channel in fluidic communication with the first anolyte return frame channel.

In aspects, the redox cell stack may include a plurality of frame plate assemblies disposed proximate to the back face of the first frame plate assembly, wherein the framing members extend through the plurality of frame plate assemblies.

In aspects, the redox cell stack may have a second cell plate of the second frame plate assembly that is monopolar.

In aspects, the redox cell stack may have a first cell plate that is bipolar.

In aspects, the redox cell stack may have the first catholyte supply frame channel comprise a radial connector insert. The radial connector insert may include a rectangular prism insert body having an opening, a sealing element adapted to couple to another frame channel, a connection element extending substantially orthogonally from a wall of the rectangular insert prism body, the connection element coupling to first catholyte supply pathway.

In aspects, the radial connector insert couples the first catholyte supply frame channel to the second catholyte supply frame channel.

In aspects, the redox cell stack has a frame that has at least one cut away to facilitate heat exchange.

In aspects, the first catholyte supply frame channel, the first catholyte return frame channel, the first anolyte supply frame channel, and the first anolyte supply frame channel is an insertably removable member.

These and various other features as well as advantages that characterize the systems and methods described herein will be apparent from a reading of the following detailed description and a review of the associated drawings. Additional features are set forth in the description which follows, and in part will be apparent from the description, or may be learned by practice of the technology. The benefits and features of the technology will be realized and attained by the structure particularly pointed out in the written description and claims hereof as well as the appended drawings.

### BRIEF DESCRIPTION OF THE DRAWINGS

Non-limiting and non-exclusive embodiments are described with reference to the following figures.

FIG. 1 illustrates an example redox flow battery environment in which aspects of the technology may be implemented.

FIG. 2 illustrates an exploded perspective view of an embodiment of a cell stack system.

FIGS. 3A and 3B illustrate an embodiment electrolyte pathways between multiple frame plate assemblies of a redox cell stack.

FIG. 4 illustrates a perspective view of an embodiment of a frame.

FIG. 5 illustrates a view of an embodiment of a face of a floating frame plate assembly.

FIG. 6 illustrates a view of a face of an embodiment of a floating frame plate assembly with electrolyte shunt pathways.

FIG. 7 illustrates a perspective view of an embodiment of a floating frame plate assembly.

FIG. 8 illustrates a side view of an embodiment of a floating frame plate assembly.

FIG. 9 illustrates a perspective view of an embodiment of a floating frame plate assembly.

FIG. 10 illustrates an embodiment of a cell plate.

FIG. 11 illustrates an exploded view of an embodiment of a frame plate assembly with insertably removable members.

FIG. 11B illustrates a perspective view of a radial connector insert.

FIGS. 12A-12D illustrate various views of an embodiment of an radial connector insert.

FIGS. 13A-13D illustrate various views of an embodiment of an insertably removable member.

### DETAILED DESCRIPTION

Aspects of the technology relate to a redox flow battery with a cell plate and a frame, together which form a frame plate assembly. In embodiments, multiple frame plate assemblies are stacked together to form a cell stack. The cell plates are fluidically coupled to the frame of the frame plate assembly. In aspects of the technology, a flexible member is used to couple a fluid channel of the frame to the cell plate. The flexible member may allow some movement between the frame and the cell plate assembly such that the cell plate may move independently from the frame. In this way, the cell may be said to be “floating” from the frame. In aspects of the technology, such independent movement may allow the frame of the frame plate assembly to have a different flatness than the flatness of the cell plate. This may allow, for some applications, a decreased manufacturing tolerance for the frame of the frame plate assembly while still maintaining an appropriately high manufacturing tolerance for the frame plate to enable proper sealing between frame plates of a cell stack assembly.

The cell stack is fluidically coupled to a reservoir, in aspects, using manifold inserts (e.g., piping) to provide electrolyte solutions from a cell reservoir to the cell stack. In aspects of the technology, the frame may house an electrolyte pathway which feeds and/or returns electrolytes from a frame channel to a cell plate. Frame channels across frame plates in a cell stack may align to form a combined channel, which channel may feed multiple cell plates of the cell stack.

FIG. 1 illustrates an embodiment of a redox-flow battery system 100 having a cell stack 120. As illustrated, redox-flow battery system 100 also includes a catholyte reservoir 102 holding a catholyte solution 124 and an anolyte reservoir 114 holding an anolyte solution 122. Additionally, catholyte current collector 108 and anolyte current collector 110 are present, as is a first pumping mechanism 116 to circulate the catholyte solution 124 from the catholyte reservoir 102 to the cell stack 120, and a second pumping mechanism 118 to circulate the anolyte solution 122 from the anolyte reservoir 114 to the cell stack 120.

In an embodiment, the redox-flow battery system 100 may be one of a vanadium-vanadium redox flow battery, a polysulfide bromide battery, an iron-chromium battery, or a manganese-vanadium redox flow battery. In an embodiment where the redox-flow battery system 100 is a vanadium redox flow battery, the catholyte solution 124 is substantially V⁵⁺ in the charged state. Additionally, where the battery is in the charged state, the anolyte solution 122 is substantially V²⁺. In an embodiment where the system is a polysulfide bromide battery, the catholyte solution 124 is substantially sodium tribromide, and the anolyte solution 122 is substantially sodium disulfide in a charged state. In an embodiment where the system is an iron-chromium battery, the catholyte solution 124 is substantially Fe³⁺, and the anolyte solution 122 is substantially Cr⁺ in a charged state. In an embodiment where the system is a manganese-vanadium battery, the catholyte solution 124 is substantially Mn³⁺, and the anolyte solution 122 is substantially Vn²⁺ in a charged state. It will be appreciated that the technologies described herein may be used with other redox-flow battery chemistries.

A cell stack 120 may include a plurality of cell plates. Each cell plate of the cell stack 120 facilitates the exchange of electrical energy between the catholyte and the electrolyte during a charge/discharge cycle. A cell plate, which includes a proton exchange membrane positioned between the two electrodes, allows the transfer of a proton from the catholyte to the anolyte during the discharge cycle. The cell plate additionally includes a current collector that facilitates the exchange of an electron from the anolyte to the catholyte during the discharge cycle. The cells stack may have cells that are in series or are in parallel. While only one cell stack 120 is illustrated, it will be appreciated that multiple cell stacks may be electrically coupled together in either series or parallel.

In an embodiment, one or more mechanical pumps are used as a first pumping mechanism 116 and a second pumping mechanism 118 to circulate the catholyte solution 124 and the anolyte solution 122, respectively. Other methods and/or equipment may be used to provide circulation of the catholyte solution 124 between the catholyte reservoir 102 and the cell stack 120, as well as to circulate the anolyte solution 122 between the anolyte reservoir 114 and the cell stack 120.

As illustrated, the catholyte reservoir 102 is fluidically coupled to the cell stack 120 by a catholyte pathway 106 (which may be a tube, a pipe, or the like), and the anolyte reservoir 114 is fluidically coupled to the cell stack 120 by an anolyte pathway 112 (which may be a tube, a pipe, or the like). It will be appreciated that one or more cell stacks 120 may be configured to be fluidically coupled together in series and/or parallel.

FIG. 2 illustrates an exploded-perspective view of a cell stack system 200. In aspects of the technology, cell stack system 200 includes a plurality of frame plate assemblies 201, which includes a first frame plate assembly 202, a second frame plate assembly 204, and a third frame plate assembly 206. As illustrated, each frame plate assembly, such as the first frame plate assembly 202, the second frame plate assembly 204, and the third frame plate assembly 206, are rectangular prisms, though they need not be.

It will be appreciated that each frame plate assembly has a front face and a back face as described further below. For example, the first frame plate assembly 202 has a front face and a back face. In aspects of the technology, the front face and the back face are substantially planar.

In aspects of the technology, the back face of the first frame plate assembly 202 is disposed proximate to the front face of the second frame plate assembly 204, the back face of the second frame plate assembly 204 is disposed proximate to the front face of the third frame plate assembly 206, and so on. A first frame plate assembly 202 includes, in embodiments, a frame and a cell plate (e.g., a monopolar or bipolar plate comprising carbon paper electrodes and a membrane), which cell plate is used to facilitate the charging/discharging of a redox flow battery. Various embodiments of frame plate assembly are discussed in further detail with references to FIGS. 4-9.

The plurality of frame plate assemblies 201 may be coupled together using one or more framing members. For example, the back face of the first frame plate assembly 202 may be coupled to the front face of the second frame plate assembly 204 using one or more framing members, the back face of the second frame plate assembly 204 may be coupled to the front face of the third frame plate assembly 206, and so on.

Coupling may occur through a variety of means. As illustrated, the plurality of frame plate assemblies 201 are coupled together using framing rods 218. The framing rods 218 orthogonally penetrate the front face and the back face of the first frame plate assembly 202. The framing rod 218 is a type of framing member. In aspects of the technology, the framing members may be rods, plates, walls, shafts, and/or any item capable of coupling each of the plurality of frame plate assemblies 201 to adjacent frame plate assemblies. In aspects of the technology, the first frame plate assembly 202 has a plurality of bores operable to receive the plurality of framing rods 218. Additionally, fasteners 208 couple the framing rods 218 to the first frame plate assembly 202. Though the illustrated fasteners 208 are bolts that couple to a threaded end of the framing rods 218, it will be appreciated that other fastening technology is contemplated.

Similarly, the second frame plate assembly 204 has a plurality of bores, which bores may be aligned with the bores of the first frame plate assembly 202 such that the plurality of framing rods 218 may be received. In alternative embodiments, other framing members may be used. The other frame plate assemblies in the plurality of frame plate assemblies 201 may have similarly aligned bores to receive the framing rods 218. As such, each frame plate assembly of the plurality of frame plate assemblies 201 may couple to the adjacent frames by sliding over the framing rods 218.

As illustrated, the plurality of framing rods 218 may be secured to a first mounting plate 212. The first mounting plate 212 may cap the top of the plurality of frame plate assemblies 201. That is, the first mounting plate 212 may be disposed on the front side of the first frame plate assembly 202. Similarly, a second mounting plate 214 may cap a last frame plate assembly 216 of the plurality of frame plate assemblies 201, the last frame plate assembly 216 being disposed at the opposite end of the plurality of frame plate assemblies 201 from the first frame plate assembly 202.

Additionally illustrated in FIG. 2 is electrolyte piping 220. The electrolyte piping 220 fluidically couples an electrolyte reservoir, such as an anolyte reservoir or catholyte reservoir, to the plurality of frame plate assemblies 201. As illustrated, the electrolyte piping 220 penetrates through the first frame plate assembly 202 through an angle orthogonal to the front face and the back face. The electrolyte piping 220 may deliver and/or return the electrolyte solution to each frame plate assembly in the plurality of frame plate assemblies 201.

The reservoirs may be the same as or similar to the electrolyte reservoirs described with references to FIG. 1. In aspects of the technology, each frame plate assembly is designed with a pathway such that an electrolyte solution may pass from the frame of a frame plate assembly to a cell plate of the frame plate assembly, and then to another frame plate assembly, and then ultimately to an electrolyte reservoir.

FIG. 3A illustrates an example catholyte pathway between multiple frame plate assemblies of a redox cell stack 300. In aspects of the technology, a catholyte solution 302 enters a first frame plate assembly 306.

The first frame plate assembly 306 may have a frame with a variety of channels, vias, membranes, porous material, and/or pathways to direct the flow of the catholyte solution 302 across a portion of the backside of the first frame plate assembly 306. In aspects, flow may be directed through a frame of the first frame plate assembly 306 into a cell portion of the first frame plate assembly 306. In aspects of the technology, flow into the cell portion of the first frame plate assembly 306 is directed across a backside of the membrane of the cell portion of the first frame plate assembly 306. Flow of the catholyte solution may be directed such that a laminar sheet-flow occurs across the backside of a membrane of a cell portion of the first frame plate assembly 306.

The catholyte solution 302 then proceeds to enter a second frame plate assembly 312. In aspects of the technology, the frame of the second frame plate assembly includes channels, vias, membranes, porous materials, and or/pathways to direct the flow of the catholyte solution 302 across a portion of a backside of the second frame plate assembly. Flow of 302 may enter and exit the frame plate assembly 312 in a similar manner as frame plate assembly 306. In aspects, flow may be directed through a frame of the second frame plate assembly 312 into a cell portion of the second frame plate assembly. In aspects of the technology, flow into the cell portion of the second frame plate assembly 312 is directed across a backside of the membrane of the cell portion of the second frame plate assembly 312. Flow of the catholyte solution 302 may be directed such that a laminar sheet-flow occurs across the backside of a membrane of the cell portion of the second frame plate assembly 312.

This pattern of flow of the catholyte solution 302 may proceed to a plurality of other frame plate assemblies, including a third frame plate assembly 318, and/or to a reservoir. Flow of 302 may enter and exit the frame plate assembly 318 in a similar manner as frame plate assembly 306. In aspects of the technology, the catholyte solution 302 enters a frame plate assembly and flow may be directed such that the catholyte solution flows down a backside portion of the membrane of a cell portion of a plate assembly.

Illustrated in FIG. 3B is a flow of an anolyte solution 314. The flow of the anolyte solution 314 is first into the first frame plate assembly 306. The first frame plate assembly 306 may have a frame with a variety of channels, vias, membranes, porous material, and/or pathways to direct the flow of the anolyte solution 314 across a portion of the frontside of the first frame plate assembly 306 (indicated by a dashed line). In aspects, flow may be directed through a frame of the first frame plate assembly 306 into a cell portion of the first frame plate assembly 306. Flow of the anolyte solution 314 may be directed such that a laminar sheet-flow occurs across the front side of a membrane of a cell portion of the first frame plate assembly 306.

An anolyte solution may travel from a first frame plate assembly 306 to the second frame plate assembly 312. The second frame plate assembly 312 may have a frame with a variety of channels, vias, membranes, porous material, and/or pathways to direct the flow of the anolyte solution 314 across a portion of the front side of the second frame plate assembly 312 (illustrated by dotted lines). In aspects, flow may be directed through a frame of the second frame plate assembly 312 into a cell portion of the second frame plate assembly 312. In aspects of the technology, flow into the cell portion of the second frame plate assembly 312 is directed across a front side of the membrane of the cell portion of the second frame plate assembly 312. Flow of the anolyte solution 314 may be directed such that a laminar sheet flow occurs across the front side of the membrane of the cell portion of the second frame plate assembly 312.

The anolyte solution 314 then proceeds to enter a third frame plate assembly 318. Flow of the anolyte solution 314 may enter and exit the frame plate assembly 318 in a similar manner as frame plate assembly 306. In aspects of the technology, the frame of the third frame plate assembly 318 includes channels, vias, membranes, porous materials, and or/pathways to direct the flow of the anolyte solution 314 across a front side of the first frame plate assembly 306. In aspects, flow may be directed through a frame of the third frame plate assembly 318 in a cell portion of the third frame plate assembly 318. In aspects of the technology, flow into the cell portion of the third frame plate assembly 318 is directed across a front side of the membrane of the cell portion of the third frame plate assembly 318. Flow of the anolyte solution 314 may be directed such that a laminar sheet flow occurs across the front side of a membrane of the cell portion of the third frame plate assembly 318.

This pattern of flow of the anolyte solution 314 may proceed to a plurality of other frame plate assemblies and/or to a reservoir. In aspects of the technology, the anolyte solution 314 enters a frame plate assembly and flow may be directed such that the anolyte solution flows down a frontside portion of the membrane.

In aspects of the technology, the catholyte solution 302 flows through a shared manifold 320 and 322. That is, in an example, each cell includes a flow path that enables an electrolyte to flow from an inlet to an outlet, and each frame plate assembly has an internal manifold insert, such as electrolyte piping 220. As illustrated, the anolyte 314 and the catholyte 302 use different electrolyte piping to travel from frame plate assembly to frame plate assembly. Thus, stacking multiple frame plate assemblies may create a common supply and return manifolds via the electrolyte piping. This internal manifold supplies and returns electrolyte to the individual cells in a parallel flow configuration, in example embodiments. Other configurations are contemplated.

FIG. 4 illustrates a perspective view of a frame 400. As illustrated, the frame 400 has a frame body 402 that is a rectangular prism. The frame body 402 may be made of a variety of materials, such as a rigid or semi-rigid plastic. In some embodiment, the frame body 402 is made of electrical isolating and heat conducting material. The frame has a substantially planar front face 406 and a substantially planar back face 404. In some aspects, portions of the frame body 402 may be removed to aid in heat exchange of a cell and the atmosphere (or other environment).

Additionally illustrated are electrolyte pathways 408. Electrolyte pathways 408 fluidically couple an electrolyte reservoir and/or other frame plate assemblies to the frame 400. For example, one or more of the electrolyte pathways 408 may be a catholyte supply pathway that delivers a catholyte solution to a cell plate, a catholyte return pathway that returns a catholyte solution to a catholyte reservoir and/or other frame plate assemblies, an anolyte supply pathway that delivers an anolyte solution to a cell plate, and/or an anolyte return pathway that returns an anolyte solution to an anolyte reservoir and/or other frame plate assemblies. As illustrated, the electrolyte pathways 408 are a cutaway adapted to receive tubing, which tubing along with the cutaway form an embodiment of the electrolyte pathways 408. In other embodiments, the electrolyte pathways 408 are formed using thermal injection molding such that the electrolyte pathway 408 is formed as a unitary construction with the frame 400.

The electrolyte pathways 408 each have a frame channel end 410 and a cell end 412. The frame channel end 410 fluidically couples the electrolyte pathways 408 to a frame channel 414. The frame channel end 410 may be an orifice that allows an electrolyte solution to flow from the frame channel 414 into an electrolyte pathway 408. Other structural items that allow the electrolyte pathways 408 to be in fluidic communication with a reservoir and/or other frame plate assemblies are contemplated.

Similarly, the cell end 412 fluidically couples the electrolyte pathway 408 to a cell plate. The cell end 412 of an electrolyte pathway 408 may be a flexible member, which flexible members are discussed in more detail herein.

Additionally illustrated is a cell plate area 416. As illustrated, the cell plate area 416 is a cutaway, opening, and/or void. The cell plate area 416 is an empty space of the frame body 402 in which a cell plate may be removably inserted. Additionally illustrated are bores 418. As illustrated, the bores 418 are circular cut-outs adapted to receive framing members, such as rods. The cell plate area may be defined as having inner walls 403.

FIG. 5 illustrates a view of a face of a floating frame plate assembly 500. It will be appreciated that elements of FIG. 5 that are similarly numbered as those of FIG. 4 have the same or similar properties as those described with reference to FIG. 4. As illustrated the floating frame plate assembly 500 includes a cell plate 502 and a frame body 402 having bores 418. Disposed at each corner of the frame body 402 are frame channels 414A-D.

The frame body 402 may be of a unitary construction. In aspects of the technology, the frame body 402 is a rectangular prism shape that is 18.5 inches in width (x), 18.5 inches in length (y), and 0.5 inches in thickness (z). The frame body 402 may be molded of electrically isolating and heat conducting materials, such as a thermally insolating plastic. The frame body 402 may have a cell plate area in which to receive the cell plate 502. The opening may be formed by cutting away an inner section of the frame body 402. In other aspects, the opening may be formed during molding of the frame body 402. In aspects of the technology the opening may be a rectangular in shape so as to accommodate the cell plate 502 that is rectangular in shape, though it need not be.

The frame channels 414A, 414B, 414C, and 414D serve to deliver (or return) electrolytes from (or to) a reservoir, such as the reservoirs described with reference to FIG. 1, to a cell plate, such as cell plate 502, and/or to adjacent frame plate assemblies within a cell stack. In aspects of the technology, the frame channels 414A, 414B, 414C, and 414D form a tube or channel throughout a plurality of frame plate assemblies within a frame plate assembly. That is, each frame channel may be coupled to another electrolyte frame channel of an adjacent frame to form a tube or channel.

In an embodiment of the technology, an electrolyte (such as an anolyte solution or a catholyte solution) may pass from a frame channel 414A through an electrolyte supply pathway 408A to a cell plate 502. Similarly, the opposite charged solution (such as a catholyte solution or an anolyte solution) may enter through frame channel 414B. The opposite charged solution may pass through electrolyte supply channel 408B to the cell plate 502. The anolyte and catholyte may interact within the cell plate 502 via the use of a proton exchange membrane (that is, a proton exchange membrane may be disposed between the two electrolytes within the body of the cell plate 502). An electrolyte return pathway 408C may deliver an electrolyte solution (such as a catholyte solution or an anolyte solution) from the cell plate 502 to frame channel 414C, and on to another floating frame plate or to a reservoir. Similarly, another electrolyte return pathway 408D returns the opposite electrolyte solution (such as an anolyte solution or a catholyte solution) from the cell plate 502 to frame channel 414C and then on to another floating frame plate assembly or to a reservoir.

The electrolyte pathways 408A, 408B, 408C, and 408D may be formed in a variety of ways. In one embodiment, tubing made of material that is substantially inert to the electrolytes are used. Where the electrolyte comprises vanadium ions, poly-vinyl chloride, high density polyurethane, and/or polypropylene tubing may be used. In other aspects of the technology, thermal molding may be used on the frame body 402 to form one or more of the electrolyte pathways 408A, 408B, 408C, and 408D.

Flexible members 512A, 512B, 512C, and 512D may couple the electrolyte pathways 408A, 408B, 408C, and 408D to the cell plate 502, respectively. For example, the flexible member 512A fluidically couples the electrolyte pathway 408A to the cell plate 502 such that the frame channel 414A is in fluidic communication with the cell plate 502. Similarly, the flexible members 512B, 512C, and 512D fluidically couple the electrolyte pathways 408B, 408C, and 408D to the cell plate 502, respectively. In aspects of the technology, the flexible members 512A, 512B, 512C, and 512D are each nipples made of high density polyethylene.

Additionally, or alternatively, the flexible member may be tubing with a press fit, snap fit, threaded connection or other connection such that the flexible member resiliently engages with a cell plate. Further, the cell plate 502 may have a receiving element adapted to receive a press fit, snap fit, threaded connection or other connection. In additional/alternative embodiments, the flexible member may be tubing having any number of flanges that extend radially out from the tubing such the nipple resiliently engages with the inner surface of the orifice of a cell plate. In aspects, the flexible member forms robust coupling with a cell plate. Additionally, the flexible member may be incorporated into the cell end of the electrolyte pathways 408A, 408B, 408C, and 408D.

In aspects of the technology, the flexible members 512A, 512B, 512C, and 512D allow the frame body 402 to move independently of the cell plate 502. For example, the flexible members 512A, 512B, 512C, and 512D may allow the frame to tilt separately from the cell plate 502 in various directions up to a certain threshold. Independent movement is discussed further with respect to FIG. 7.

FIG. 6 illustrates a view of a face of a floating frame plate assembly 600 with electrolyte shunt pathways 608A, 608B, 608C, and 608D. It will be appreciated that elements of FIG. 6 that are like numbered as those elements in FIG. 4 and FIG. 5 have the same or similar properties as those like numbered elements described with reference to FIG. 4 and FIG. 5. As illustrated, floating frame plate assembly 600 includes a cell plate 502, a frame body 402, bores 418, frame channel 414, and flexible members 512A, 512B, 512C, and 512D.

Electrolyte shunt pathways 608A, 608B, 608C, and 608D are illustrated. In aspects of the technology, a catholyte or electrolyte solution passes through frame channels 414A, 414B, 414C, and 414D and then proceeds to the electrolyte shunt pathways 608A, 608B, 608C, and 608D, respectively. It will be appreciated that electrolyte shunt pathways may have similar properties as those describe with respect to electrolyte pathways 408A, 408B, 408C, and 408D. Additionally, in aspects of the technology, the electrolyte solution traverses a specified length of the electrolyte shunt pathways (e.g., electrolyte shunt pathways 608A, 608B, 608C, and 608D) prior to entering the cell plate 502. Additionally, the length of path may be tuned to a specific electrical resistance and fluid resistance ratio. For example, in certain applications, it may be desirous to increase electrical resistance to prevent shunt currents within a floating frame plate assembly 600 and/or across frame plate assemblies within a cell stack. Additionally, for certain applications, it may be desirous to decrease fluid resistance within a floating frame plate assembly 600 and/or across cell assemblies within a cell stack.

In aspects of the technology, electrical resistance is controlled by changing various elements of the floating frame plate assembly 600. For example, the material of the electrolyte shunt pathways, the length of the electrolyte shunt pathways, the size and shape of the electrolyte shunt pathways (e.g., diameter of the electrolyte shunt pathways where the electrolyte shunt pathways is a cylindrical tubing), the material, the size, and the shape of a flexible member, and the material, size, and shape of the frame channel nipples (e.g., frame channel nipples 620A, 620B, 620C, and 620D) may alter the electrical resistance in the floating frame plate assembly 600.

Similarly, the fluid flow resistance may be controlled by changing various elements of the floating frame plate assembly 600. For example, the material of the electrolyte shunt pathways, the length of the electrolyte shunt pathways, the size (e.g., diameter of the electrolyte shunt pathways where the electrolyte shunt pathways is a cylindrical tubing) and shape (e.g., a electrolyte shunt pathways with an oval cross-section, a rectangular cross section, a circular cross section) of the electrolyte shunt pathways, the material, the size, and the shape of a flexible members 512, and the material, size, and shape of the frame channel nipples 620 may alter the fluidic resistance in the floating frame plate assembly 600.

In an embodiment of the technology the material of the electrolyte shunt pathways 608A, 608B, 608C, and 608D is one of poly-vinyl chloride, high density polyurethane, or polypropylene. In embodiments, the shunt path may be tubular in shape having a defined length and diameter.

As illustrated, electrolyte shunt pathways 608A, 608B, 608C, and 608D take a corkscrew path around a cell plate 502, though it need not take such a path. Rather, the electrolyte shunt pathways may take a variety of paths, which path may be designed to increase/decrease electrical resistance while decreasing/increasing fluidic resistance. For example, a variety of bends, curves, etc. may be designed to alter the fluid resistance and/or the electrical resistance that an electrolyte solution is subject to during flow within and/or through the floating frame plate assembly 600.

FIG. 7 is a perspective view of a floating frame plate assembly 700. It will be appreciated that elements of FIG. 7 that are like numbered as those elements in FIG. 4, FIG. 5, and FIG. 6 have the same or similar properties as those like numbered elements described with reference to FIG. 4, FIG. 5, and FIG. 6. As illustrated, floating frame plate assembly 700 includes a cell plate 502, frame channels 414A, 414B, 414C, and 414D, flexible members 512A, 512B, 512C, and 512D, a frame body 402, electrolyte shunt pathways 608A, 608B, 608C, and 608D and bores 418.

FIG. 7 also illustrates a first horizontal axis 702, a second horizontal axis 704, and a vertical axis 706. A pitch angle 708, a roll angle 710, and a yaw angle 712 are also illustrated. In embodiments, the first horizontal axis 702 is an axis that extends radially out from a first side wall 714 of the floating frame plate assembly 700 and is parallel to the front face 716 of the floating frame plate assembly 700. Additionally, in embodiments, the second horizontal axis 704 extends radially from the second side wall 718 and is orthogonal to the first horizontal axis 702. Further, in embodiments, the vertical axis 706 extends orthogonally outwards from the front face 716 of the floating frame plate assembly 700.

As discussed previously, the flexible members 512A, 512B, 512C, and 512D may allow the cell plate 502 to move independently from the frame body 402. Such independent movement allows for, in embodiments, the frame body 402 to be manufactured thinner and manufactured less precisely with respect to flatness and thickness. That is, because the cell plates seal together, the manufacturing tolerances on the sealing elements of each cell plate in a plurality of cell plates must, in embodiments, be sufficiently high to reduce leaking of the electrolyte fluid. Decoupling the movement of the frame body 402 from the cell plate 502 allows for the frame body to locate and orient a cell on framing members while reducing or preventing the frame body from interfering with a cell sealing with an adjacent cell.

For example, the flexible members may allow the cell plate 502 to rotate about the first horizontal axis 702 up to a pitch angle 708 of between +/−1 degree while the frame body 402 maintains a pitch angle of 0 degrees. Additionally, the flexible members 512A, 512B, 512C, and 512D may allow the cell plate 502 to rotate about the second horizontal axis 704 up to a roll angle 710 of between +/−1 degree while the frame body 402 maintains a pitch angle of 0 degrees. Additionally, the flexible members 512A, 512B, 512C, and 512D may allow the cell plate 502 to rotate about the vertical axis 706 up to a yaw angle 712 of between +/−1 degrees while the frame body 402 maintains a pitch angle of 0 degrees. In other aspects, the degree angle may be greater. For example, the degree angle of each angle of rotation may be +/−3.

FIG. 8 illustrates a side cut-out view of a floating frame plate assembly 800. It will be appreciated that elements of FIG. 8 that are like numbered as those elements in FIG. 4, FIG. 5, FIG. 6, and FIG. 7 have the same or similar properties as those like numbered elements described with reference to FIG. 4, FIG. 5, FIG. 6, and FIG. 7. As illustrated, floating frame plate assembly 800 includes a cell plate 502, frame channel 414, and a frame body 402. The floating frame plate assembly 800 has a frame height 802, a frame length 804, a cell plate height 806, and a cell plate length 808. In aspects of the technology, the frame height 802 may be 0.375″ to 0.625″, the frame length 804 15″ to 20″, the cell plate height 806 may be greater than the frame height 802, the cell plate length 808 may be 8″ to 12″. In aspects of the technology, the frame height 802 is less than the cell plate height 806.

FIG. 9 illustrates a perspective view a floating frame plate assembly 900. It will be appreciated that elements of FIG. 9 that are like numbered as those elements in FIG. 4, FIG. 5, FIG. 6, FIG. 7, and FIG. 8 have the same or similar properties as those like numbered elements described with reference to FIG. 4, FIG. 5, FIG. 6, FIG. 7, and FIG. 8. As illustrated, floating frame plate assembly 800 includes a cell plate 502 and a frame body 402.

A frame body flatness 902 is illustrated, as is a cell plate flatness 904. A frame body flatness 902 measures the flatness of a frame body from one point of a frame body to another. As illustrated, the frame body flatness 902 is measured from one corner of a face of the frame body 402 (which, as illustrated is a rectangular prism) to an opposite corner on the same face of the frame body. Flatness may be described in millimeters of change in height versus millimeters of change in length. In aspects of the technology, the frame body may be manufactured to have a flatness 902 of greater than 0.005″ per linear 1″. In alternative embodiments, the frame body flatness 902 may have a flatness of greater than 0.005 mm per 1 mm.

Additionally illustrated is cell plate flatness 904, which measures the flatness of a cell from one point of a frame to another. As illustrated, the flatness is measured from one corner of a face of the cell plate 502 (which, as illustrated is a rectangular prism) to an opposite corner on the same face of the cell plate 502. Flatness may be described in millimeters of change in height versus millimeters of change in length. In aspects of the technology, the frame may be manufactured to have a flatness of at least 0.0005″ per linear 1″. In alternative/additional embodiments, the flatness may be at least 0.0005 mm per 1 mm.

It will be appreciated that one or more flexible members, such as those described above with respect to FIG. 5, allows a plurality of cell with a certain flatness tolerance to be coupled together, while the frames of each of the plurality of cells to be at a lower flatness tolerance.

FIG. 10 illustrates a perspective view of a cell plate 1000. In aspects of the technology, the cell plate 1000 includes a first orifice 1002, a second orifice 1004, a third orifice 1006, and a fourth orifice 1008. As illustrated the first orifice 1002, the second orifice 1004, the third orifice 1006, and the fourth orifice 1008 are circular in shape. In aspects of the technology, the orifice may be adapted to receive a flexible member, such as the flexible members described herein. For example, where the flexible member is threaded, the first orifice may have threads about an inner annular surface of an orifice. Where the flexible member is a cylindrical tube or nipple and has a number of flanges extending radial outward from the cylinder, the inner annular surface of an orifice may have corresponding ridge, which may receive the flanges of the cylindrical tubing or nipple. Additionally or alternatively, the nipple of the flexible member may be tapered such that the flexible member may be insertably removed from an orifice, such as a first orifice 1002.

As illustrated, the cell plate is a rectangular prism with a front face 1012 and a back face 1014. The cell plate may be coupled to a redox flow battery through the use of flexible members. For example, a flexible member may couple to an orifice, such as first orifice 1002, the second orifice 1004, the third orifice 1006, and the forth orifice 1008, and fluidically couple the cell plate 1000 to an electrolyte reservoir and or other cells within a cell stack.

In aspects of the technology, the cell plate 1000 includes one or more heat exchange elements. For example, a first heat exchange element 1010 may be coupled to a first wall 1018, a second heat exchange element 1012 may be coupled to a second wall 1020, a third heat exchange element 1014 may be coupled to a third wall 1022, and a fourth heat exchange element 1016 may be coupled to a fourth wall 1024. As illustrated, the heat exchange element is a fin that protrudes from a wall and runs length-wise along the wall. In other embodiments, the heat exchange element may be a series of teeth or other structure that aids in dissipating heat from the cell plate 1000.

FIG. 11 illustrates an exploded view of an embodiment of a frame plate assembly 1100 with insertably removable members 1102A, 1102B, 1102C, 1102D. It will be appreciated that elements of FIG. 11 like numbered as elements described above will have the same or similar properties as those elements described above. As illustrated, frame plate assembly 1100 includes a cell plate 502, flexible members 512A, 512B, 512C, and 512D, a frame body 402, electrolyte shunt pathways 608A, 608B, 608C, and 608D.

Additionally illustrated are insertably removable members 1102A, 1102B, 1102C, and 1102D. The insertably removable members 1102A, 1102B, 1102C, and 1102D insertably remove into the frame channel area 1104A, 1104B, 1104C, and 1104D of the frame body 1108. As illustrated, each of the insertably removable members 1102A, 1102B, 1102C, and 1102D is a rectangular prism, though they need not be. For example, other geometries are contemplated, including cylindrical shapes.

In aspects of the technology, the insertably removable members 1102A, 1102B, 1102C, and 1102D and the frame channel area 1104A, 1104B, 1104C, and 1104D form all or a part of a frame channel when the insertably removable members 1102A, 1102B, 1102C, and 1102D are inserted into their respective frame channel areas.

One advantage of having an insertably removable member form all or a part of a frame channel is it may allow for easier manufacturing. In use, frame channels of one frame plate assembly may couple to frame channels of another, adjacent frame plate assembly. As such, it is desirable, in aspects, to have the frame channels form a robust seal with the other frame channels. One reason is that a robust seal will aid in reducing leakage of the electrolyte solution as the electrolyte solution flows from frame plate assembly to frame plate assembly. To achieve a robust seal, it is beneficial, in aspects, to manufacture each frame channel to couple robustly with its adjacent frame channel. In some aspects, this means manufacturing complementary geometries between two adjacent frame channels. For example, where two frame channels couple together via a substantially planar face having a sealing element, such as an o-ring, the degree to which both frame channel's coupling surfaces are flat may aid in maintaining a robust seal. Having an insertably removable members form all or a part of the frame channel may allow for the insertably removable members to be manufactured at high precision levels without necessarily needing to have the rest of the frame body 1108 be at such a high precision level. For some manufacturing processes, this may decrease the overall manufacturing cost and complexity. Examples of insertably removable members 1102A, 1102B, 1102C, and 1102D are discussed further with reference to FIGS. 12A-FIG. 13D.

FIGS. 12A-12D illustrate various views of an embodiment of an insertably removable member. In particular, FIG. 12A, FIG. 12B, FIG. 12C, and FIG. 12D illustrate a front, side, perspective, and back view of an insertably removable member that is a radial connector insert 1200, respectively. A radial connector insert 1200 may be used to allow an electrolyte solution to flow from one frame channel of a first frame plate assembly to a second frame channel of an adjacent, second frame plate assembly. Additionally, the radial connector insert 1200 includes a connection element 1202 which, in operation, fluidically couples a cell of the frame plate assembly to other frame place assemblies and/or an electrolyte reservoir. As illustrated, radial connector insert 1200 includes a rectangular prism insert body 1203. In other aspects, the body 1203 may be a different shape.

As illustrated, the radial connector insert 1200 has an opening 1210 that allows, in aspects, an electrolyte to flow from one frame plate assembly to another frame plate assembly and/or to an electrolyte reservoir. Indeed, each radial connector insert 1200 may have a sealing element 1212 that protrudes from a front face 1214 of the radial connector insert 1200 and may be adapted to couple to a back face 1216 of an adjacent insertably removable member. As illustrated, the sealing element 1212 protrusion is defined by a perimeter of the opening 1210. The protrusion has a face 1218 that may be substantially planar. In some aspects, the face 1218 of the sealing element 1212 may couple to an o-ring or other material to aid in forming a robust seal with an adjacent frame channel (the adjacent frame channel may be another insertably removable member).

An attachment element 1220 may correspond to a receiving element of a frame, such as the frame described with reference to FIG. 11. For example, an attachment element 1220 may be a tongue that protrudes from a side wall of the radial connector insert 1200 and inserts into a slot of the frame. In other aspects, other attachment elements may be used, such as snap fittings. This may allow the radial connector insert 1200 to be removably inserted into the frame body of a frame plate.

Additionally illustrated is a connection element 1202. As illustrated, the connection element 1202 extends orthogonally from the first wall 1222 of the body 1203. In aspects of the technology, the connection element 1202 may be a tube with a press fit, snap fit, threaded connection or other connection such that the connection element resiliently engages with a frame end of an electrolyte pathway, such as an anolyte or catholyte pathway described with more detail above. In aspects, this allows the frame channel to be in fluidic communication with one or more cell plates. For example, in aspects, the connection element 1202 has a pathway 1224 that fluidically couples the opening 1210 to a cell of a frame plate assembly when in operation. Specifically, the opening 1210 may be defined by an annular wall 1226. Additionally, the pathway 1224 may be through the body 1203 to opening on the annular wall 1226.

FIGS. 13A-13D illustrate various views of an embodiment of an insertably removable member. In particular, FIG. 13A, FIG. 13B, FIG. 13C, and FIG. 13D illustrate a front, side, perspective, and back view of an insertably removable member that is a radial spacer insert 1300. A radial spacer insert 1300 may be used to allow an electrolyte solution to flow from one frame channel of a first frame plate assembly to a second frame channel of a second frame plate assembly. As illustrated, a radial spacer insert 1300 includes a rectangular prism insert body 1302. In other aspects, the body 1302 may be a different shape.

As illustrated, the radial spacer insert 1300 has an opening 1310 that allows, in aspects, an electrolyte to flow from one frame plate assembly to another, adjacent frame plate assembly. Indeed, a radial spacer insert 1300 may have a sealing element 1312 that protrudes from a front face 1314 of the radial spacer insert 1300 and may be adapted to couple to a back face 1316 of an adjacent insertably removable member. As illustrated, the sealing element is a protrusion, which protrusion is defined by a perimeter of the opening 1310. The protrusion has a face 1318 that may be substantially planar. In some aspects, the face 1318 of the sealing element 1312 may couple to an o-ring or other material to aid in forming a robust seal with an adjacent frame channel (part or all of the adjacent frame channel may be another insertably removable member).

An attachment element 1320 may correspond to a receiving element of a frame, such as the frame described with reference to FIG. 11. For example, an attachment element 1320 may be a tongue that protrudes from a side wall and inserts into a slot of the frame. In other aspects, other attachment elements may be used, such as snap fittings. This may allow the radial spacer insert to be insertably removable into the frame body of a frame plate.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

1. A redox cell stack comprising:
a frame comprising a plurality of electrolyte frame channels in fluidic communication with a plurality of electrolyte pathways, each electrolyte pathway coupled to a flexible member; and
a cell plate coupled to each flexible member such that the frame and cell plate float relative to each other in a cell stack of a redox flow battery;
wherein the frame, the plurality of electrolyte pathways, and the cell form a first frame plate assembly.

2. A redox cell stack comprising:
a frame having a rectangular prism body with a front face, a back face, and four side faces, the frame having:
a first catholyte supply frame channel disposed on the rectangular prism body, a first catholyte return frame channel disposed on the rectangular prism body, a first anolyte supply frame channel disposed on the rectangular prism body, and a first anolyte supply frame channel disposed on the rectangular prism body;
a first catholyte supply pathway disposed within the rectangular prism body, wherein the first catholyte supply pathway is in fluidic communication with the first catholyte supply frame channel, the first catholyte supply pathway having a frame channel end and a cell end, the cell end being coupled to a first flexible member;
a first catholyte return pathway disposed within the rectangular prism body, wherein the first catholyte return pathway is in fluidic communication with the first catholyte return frame channel, the first catholyte return pathway having a frame channel end and a cell end, the cell end being coupled to a second flexible member;
a first anolyte supply pathway disposed within the rectangular prism body, wherein the first anolyte supply pathway is in fluidic communication with the first anolyte supply frame channel, the first anolyte supply pathway having a frame channel end and a cell end, the cell end being coupled to a third flexible member; and
a first anolyte return pathway disposed within the rectangular prism body, wherein the first anolyte return pathway is in fluidic communication with the first anolyte return frame channel, the first anolyte return pathway having a frame channel end and a cell end, the cell end being coupled to a fourth flexible member;
a first cell plate having a first orifice coupled to the first flexible member, a second orifice coupled to the second flexible member, the third orifice coupled to the third flexible member, and the fourth orifice coupled to the fourth flexible member,
wherein the frame, the first catholyte supply pathway, the first catholyte return pathway, the first anolyte supply pathway, the first cell plate, and the cell form a first frame plate assembly.

3. The redox cell stack of claim 2, wherein the cell plate has a flatness of at least 0.0005″ per linear 1″ while the frame body has a flatness of greater than 0.005″ per linear 1″.

4. The redox stack of claim 2, wherein the cell plate rotates about a pitch axis up to 3° degrees while the frame remains stationary relative to the cell plate.

5. The redox cell stack of claim 2, further comprising:
at least one framing member extending through the frame body substantially orthogonal to the front face and the back face;
a second frame plate assembly disposed proximate to the front face of the first frame plate assembly, wherein the framing members extend through a second frame body of a second front face and a second back face of the second frame plate assembly;
the second frame plate assembly having:
a second catholyte supply frame channel in fluidic communication with the first catholyte supply frame channel;
a second catholyte return frame channel in fluidic communication with the first catholyte return channel;
a second anolyte supply frame channel in fluidic communication with the first anolyte supply frame channel; and
a second anolyte return frame channel in fluidic communication with the first anolyte return frame channel.

6. The redox cell stack of claim 5 further comprising:
a plurality of frame plate assemblies disposed proximate to the back face of the first frame plate assembly, wherein the framing members extend through the plurality of frame plate assemblies.

7. The redox cell stack of claim 5, wherein a second cell plate of the second frame plate assembly is monopolar.

8. The redox cell stack of claim 2, wherein the first cell plate is bipolar.

9. The redox cell stack of claim 2, wherein the first catholyte supply frame channel comprises a radial connector insert, the radial connector insert comprising:
a rectangular prism insert body having an opening;
a sealing element adapted to couple to another frame channel;
a connection element extending substantially orthogonally from a wall of the rectangular insert prism body, the connection element coupling to first catholyte supply pathway.

10. The redox cell stack of claim 6, wherein the radial connector insert couples the first catholyte supply frame channel to the second catholyte supply frame channel.

11. The redox cell stack of claim 2, wherein the frame has at least one cut away to facilitate heat exchange.

12. The redox cell stack of claim 2, wherein at least one of the first catholyte supply frame channel, the first catholyte return frame channel, the first anolyte supply frame channel, and the first anolyte supply frame channel is an insertably removable member.

13. A frame plate assembly comprising:
a rectangular prism body;
an cell plate area opening defined by the rectangular prism body;
an electrolyte pathway defined by the rectangular prism body, the electrolyte pathway having a cell end and a frame channel end, the cell end terminating at the cell plate area opening;
a frame channel defined by the rectangular prism body, the frame channel end terminating at the frame channel;
a cell plate disposed within the cell plate area; and
a flexible member coupling the cell end to the cell plate.

14. The frame plate assembly of claim 13, wherein the rectangular prism body comprises a plastic.

15. The frame plate assembly of claim 13, wherein the electrolyte pathway comprises tubing.

16. The frame plate assembly, wherein the electrolyte pathway has a length determined to reduce electrical shunt pathways.

17. The frame plate assembly of claim 13, wherein the flexible member couples to an orifice of the cell plate using a flange type connector.

18. The frame plate assembly of claim 13, wherein the cell plate may move about an axis of rotation 3 degrees while the body remains relatively stationary.

19. The frame plate assembly of claim 13, wherein the frame plate assembly is in fluidic communication with another frame plate assembly.

20. The frame plate assembly of claim 13, wherein the flexible member comprises a flexible plastic.
